(19) United States
(12) Patent Application Publication
(10) Pub. No.: US 2025/0357039 A1
(43) Pub. Date: Nov. 20, 2025

(54) TRANSFORMER

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Takashi YAMADA, Nisshin-shi (JP)

(21) Appl. No.: 19/037,498

(22) Filed: Jan. 27, 2025

(30) Foreign Application Priority Data
May 16, 2024 (JP) 2024-080331

(51) Int. Cl. H01F 27/28

(52) U.S. Cl. CPC H01F 27/2804; H01F 2027/2809; H01F 2027/2814

(57) ABSTRACT

A transformer includes a printed circuit board having a first coil. The first coil is formed by a wiring pattern on a conductor layer. The transformer further includes a second coil disposed outside the printed circuit board to oppose the first coil. In the transformer, the first coil is formed on the printed circuit board using the wiring pattern, and the second coil is prepared separately from the printed circuit board.

### CROSS REFERENCE TO RELATED APPLICATION

This application is based on Japanese Patent Application No. 2024-080331 filed on May 16, 2024, the disclosure of which is incorporated herein by reference.

### TECHNICAL FIELD

The present disclosure relates to a transformer.

### BACKGROUND

A transformer has a wiring pattern on a printed circuit board. In the transformer, a coil is made by connecting wiring patterns of one or more conductor layers. A transformer includes two or more coils. In the transformer, wiring patterns of one or more conductor layers form a primary coil, and wiring patterns of another one or more conductor layers form a secondary coil.

### SUMMARY

According to an aspect of the present disclosure, a transformer includes a printed circuit board having a first coil formed by a wiring pattern on a conductor layer, and a second coil arranged outside the printed circuit board to oppose the first coil.

### BRIEF DESCRIPTION OF DRAWINGS

FIG. 1 is a perspective view of a transformer according to a first embodiment.

FIG. 2 is an exploded perspective view of the transformer of the first embodiment.

FIG. 3 is a cross-sectional view taken along line III-III in FIG. 1.

FIG. 4 is a cross-sectional view taken along line IV-IV in FIG. 1.

FIG. 5 is a cross-sectional view of a transformer according to a second embodiment.

FIG. 6 is a perspective view of a transformer according to a third embodiment.

FIG. 7 is an exploded perspective view of the transformer of the third embodiment.

FIG. 8 is a cross-sectional view taken along line VIII-VIII in FIG. 6.

### DESCRIPTION OF EMBODIMENTS

A transformer has a wiring pattern on a printed circuit board. In the transformer, one coil is made by connecting wiring patterns of one or more conductor layers. A transformer includes two or more coils. In the transformer, wiring patterns of one or more conductor layers form a primary coil, and wiring patterns of another one or more conductor layers form a secondary coil.

In a transformer using a printed circuit board, each coil is formed on a conductor layer. When a printed circuit board having many conductor layers is used, the volume of the printed circuit board increases. The present disclosure provides a transformer with a small-volume printed circuit board.

A transformer disclosed in this specification includes: a printed circuit board having a first coil formed by a wiring pattern on a conductor layer; and a second coil arranged outside the printed circuit board to face the first coil. In a transformer of a comparative example, each of the coils is formed on a printed circuit board. In contrast, in the transformer disclosed in this specification, only the first coil is formed on the printed circuit board using the wiring pattern, and a second coil is prepared separately from the printed circuit board. This structure allows the volume of the printed circuit board on which the transformer is mounted to be reduced. The first coil may be a primary coil, or the second coil may be a primary coil.

The second coil may typically be a flat wire wound edgewise more than one turn. When the second coil is made of the flat wire, the second coil does not include a substrate. Furthermore, by using the second coil made of the flat wire wound more than once, a thin transformer having a large inductance can be realized.

The second coil may be joined to the conductor layer on which the first coil is formed. The first coil can be joined without increasing the number of layers of the printed circuit board.

The flat wire may be covered with an insulating coating, and a dielectric breakdown voltage of the insulating coating may be higher than a dielectric breakdown voltage of an insulating layer of the printed circuit board. Insulation between the flat wire and the printed circuit board can be ensured by the thin insulating coating.

A gap may be provided between the second coil and the printed circuit board. Insulation between the second coil and the printed circuit board can be ensured by the gap.

The second coil may be a coil formed by a wiring pattern on a sub-board that is smaller than the printed circuit board. By employing the second coil on the sub-board that is smaller than the printed circuit board, the volume of the printed circuit board can be made smaller than that of a conventional transformer.

A protrusion may be provided on one of the printed circuit board and the sub-board, and the other of the printed circuit board and the sub-board may be in contact with the protrusion. A gap can be reliably secured between the printed circuit board including the first coil and the sub-board including the second coil.

### First Embodiment

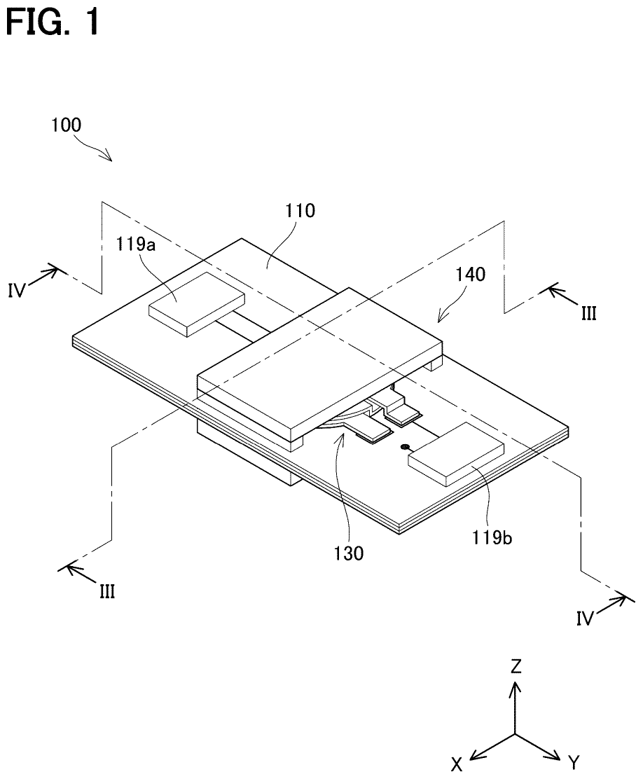

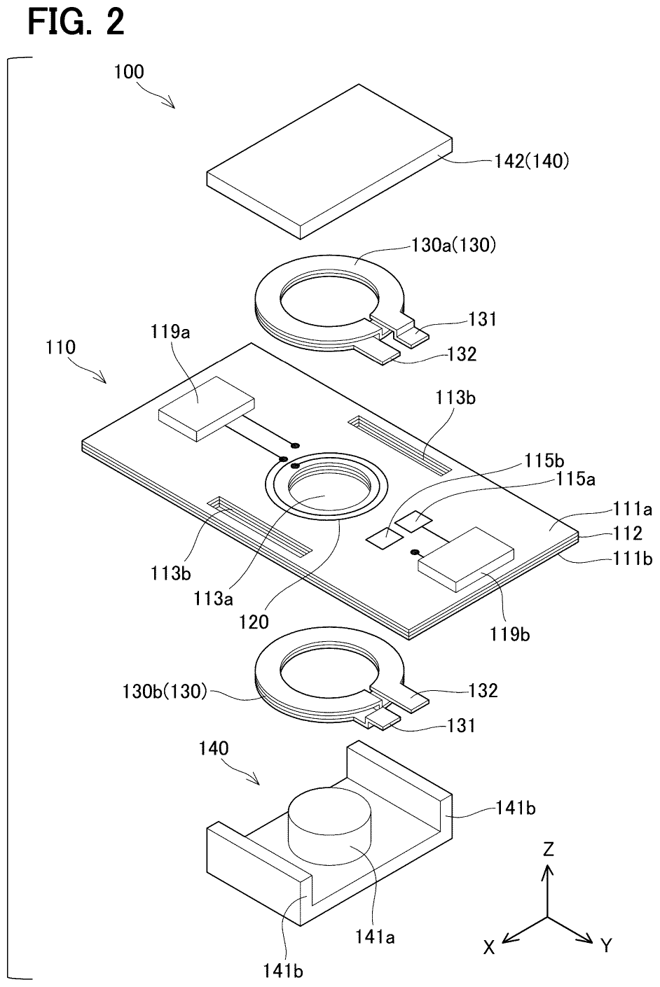

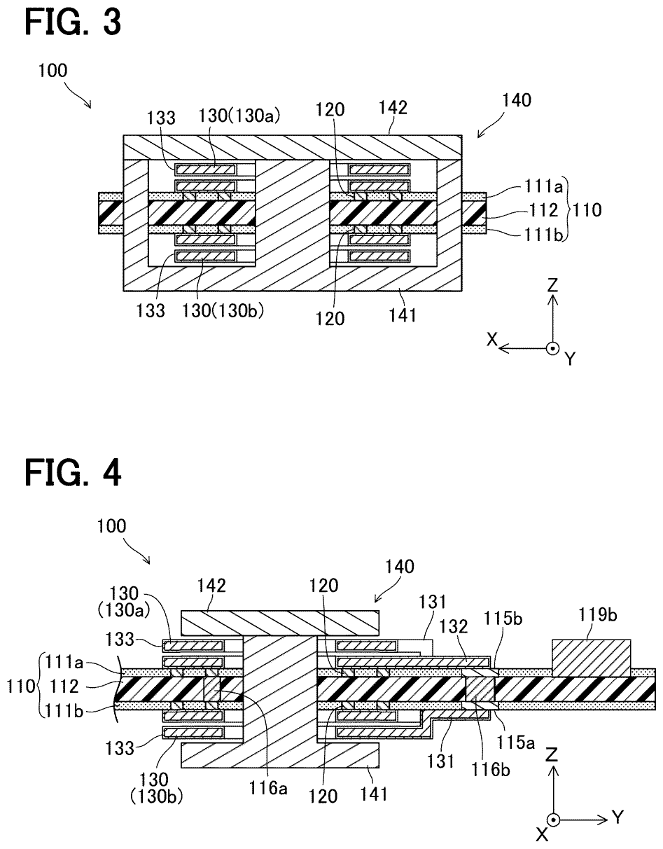

A transformer 100 according to a first embodiment will be described with reference to FIGS. 1 to 4. FIG. 1 is a perspective view of a transformer 100. FIG. 2 is an exploded perspective view of the transformer 100. FIG. 3 is a cross-sectional view of the transformer 100 taken along line III-III in FIG. 1. FIG. 4 is a cross-sectional view of the transformer 100 taken along line IV-IV in FIG. 1.

The transformer 100 includes a printed circuit board 110, a first coil 120, a second coil 130, and a core 140. As shown in FIGS. 3 and 4, the printed circuit board 110 has a three-layer structure in which an insulating layer 112 is interposed between a first conductor layer 111a and a second conductor layer 111b. For ease of explanation, one surface of the printed circuit board 110 adjacent to the first conductor layer 111a will be referred to as a front surface, and the other surface of the printed circuit board 110 adjacent to the second conductor layer 111b will be referred to as a back surface.

The printed circuit board 110 has a circular through hole 113a and a rectangular through hole 113b. The first coil 120 is formed by a wiring pattern on the conductor layer 111a, 111b. The first coil 120 is formed to extend around the circular through hole 113a of the printed circuit board 110. A coil is formed by a wiring pattern on each of the first conductor layer 111a and the second conductor layer 111b, and the coils are connected with each other in series through a via 116a (FIG. 4) passing through the printed circuit board 110. The first coil 120 is connected to a control element 119a by separate wiring pattern formed on both sides of the printed circuit board 110. The control element 119a controls the current flowing through the first coil 120.

The second coil 130 has two coils 130a and 130b. The coils 130a and 130b are arranged on the front side and the back side of the printed circuit board 110, respectively. Ends of the coil 130a are connected to support portions 131 and 132, respectively. The support portions 131 and 132 are respectively connected to terminals 115a and 115b formed on the conductor layer 111a of the printed circuit board 110. The coil 130a is fixed to the printed circuit board 110 by joining the support portion 131, 132 to the terminal 115a, 115b. The same applies to the coil 130b. The two coils 130a, 130b are connected in series to one of the terminals 115a, 115b through the via 116b (FIG. 4). The coils 130a and 130b connected in series form the second coil 130. The second coil 130 is disposed to surround the through hole 113a of the printed circuit board 110 and opposes the first coil 120. Both ends of the second coil 130 are connected to the control element 119b by wiring patterns formed on the conductor layer 111a, 111b.

The first coil 120 and the second coil 130 face each other to form a transformer. When a current flows through the first coil 120, an induced current flows through the second coil 130. The control element 119b rectifies the induced current generated in the second coil 130.

The core 140 includes an E-shaped core 141 and a flat core 142. The E-shaped core 141 includes a cylinder 141a and rectangular columns 141b, 141b. The cylinder 141a passes through the through hole 113a of the printed circuit board 110, and the rectangular column 141b, 141b passes through the through hole 113b, 113b. The flat core 142 connects the end of the cylinder 141a, which passes through the through hole 113a, to the end of the rectangular column 141b, which passes through the through hole 113b. As shown in FIG. 3, the core 140 passes through the first coil 120 and the second coil 130 and surrounds the first coil 120 and the second coil 130. When a current flows through the first coil 120, a magnetic field is generated in the core 140. A strong induced current is generated in the second coil 130 due to the magnetic field generated in the core 140.

The transformer 100 of the first embodiment includes the printed circuit board 110, the first coil 120, the second coil 130, and the core 140. The printed circuit board 110 has the conductor layers 111a, 111b and the insulating layer 112 interposed between the conductor layers 111a, 111b. The first coil 120 is formed by wiring patterns of the conductor layers 111a, 111b on both sides of the printed circuit board 110. The second coil 130 is made of an edgewise-wound flat rectangular wire. The second coil 130 is fixed to the printed circuit board 110 and is disposed outside the printed circuit board 110. In other words, the second coil 130 is adjacent to the printed circuit board 110 in the normal direction of the printed circuit board 110. The second coil 130 faces the first coil 120. The core 140 passes through the first coil 120 and the second coil 130. The transformer 100 includes the first coil 120 formed by the wiring pattern on the printed circuit board 110, and the second coil 130 arranged outside the printed circuit board 110, thereby enabling the volume of the printed circuit board 110 to be reduced.

As shown in FIG. 2, the second coil 130 is made of the two coils 130a and 130b wound edgewise into two turns. The two coils 130a, 130b are connected in series. That is, the second coil 130 is made of a flat rectangular wire wound four times. By using a flat wire wound multiple times, the second coil 130 is thin and has a large inductance. Furthermore, by using the flat wire, the second coil 130 can withstand a large current.

The flat wire of the second coil 130 is covered with an insulating coating 133 (FIGS. 3 and 4). The dielectric breakdown voltage of the insulating coating 133 is higher than the dielectric breakdown voltage of the insulating layer 112 of the printed circuit board 110. Insulation between the flat wire of the second coil 130 and the printed circuit board 110 can be ensured by the insulating coating 133.

The second coil 130 is joined to the conductor layer 111a, 111b of the printed circuit board 110 via the support portion 131, 132. The first coil 120 is formed on the conductor layer 111a, 111b. The second coil 130 is fixed to the conductor layer 111a, 111b on which the first coil 120 is formed. By joining the second coil 130 to the conductor layer 111a, 111b on which the first coil 120 is formed, there is no need to add a separate layer to the printed circuit board 110 for fixing the second coil 130.

### Second Embodiment

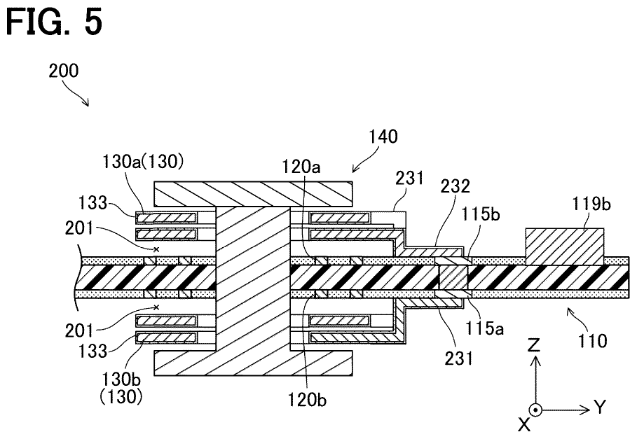

FIG. 5 shows a cross-sectional view of a transformer 200 according to a second embodiment. The transformer 200 differs from the transformer 100 of the first embodiment in that an air gap 201 is provided between the printed circuit board 110 and the second coil 130. The other structure of the transformer 200 is the same as that of the transformer 100 of the first embodiment.

The transformer 200 includes two coils 130a and 13b that form the second coil 130. The support portions 231, 232 are connected to the coil ends of the two coils 130a, 130b, respectively. The height of the support portion 231, 232 (the length in the normal direction of the printed circuit board) is greater than the height of the support portion 131, 132 of the first embodiment. Since the two coils 130a, 130b are supported by the high support portions 231, 232, the air gap 201 is secured between the second coil 130 and the printed circuit board 110. The air gap 201 ensures insulation between the second coil 130 and the printed circuit board 110 (the first coil 120).

### Third Embodiment

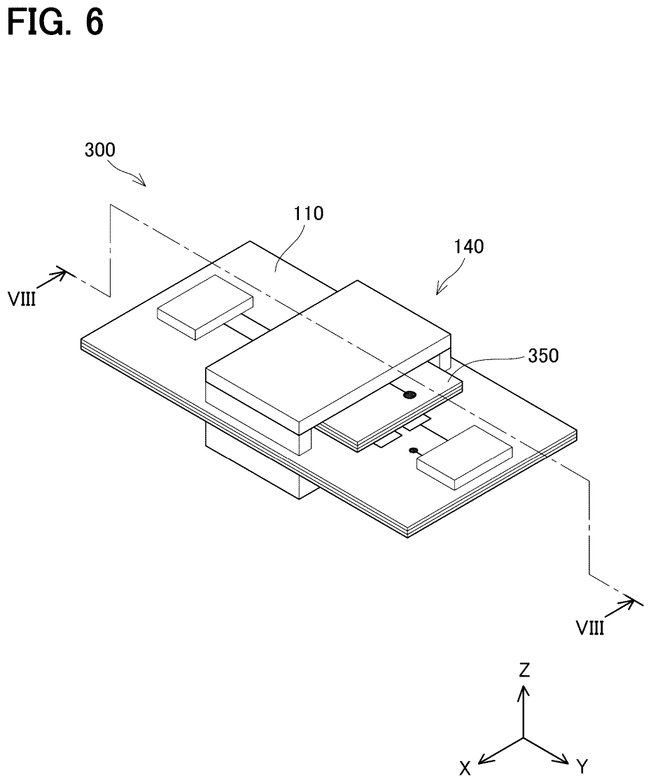

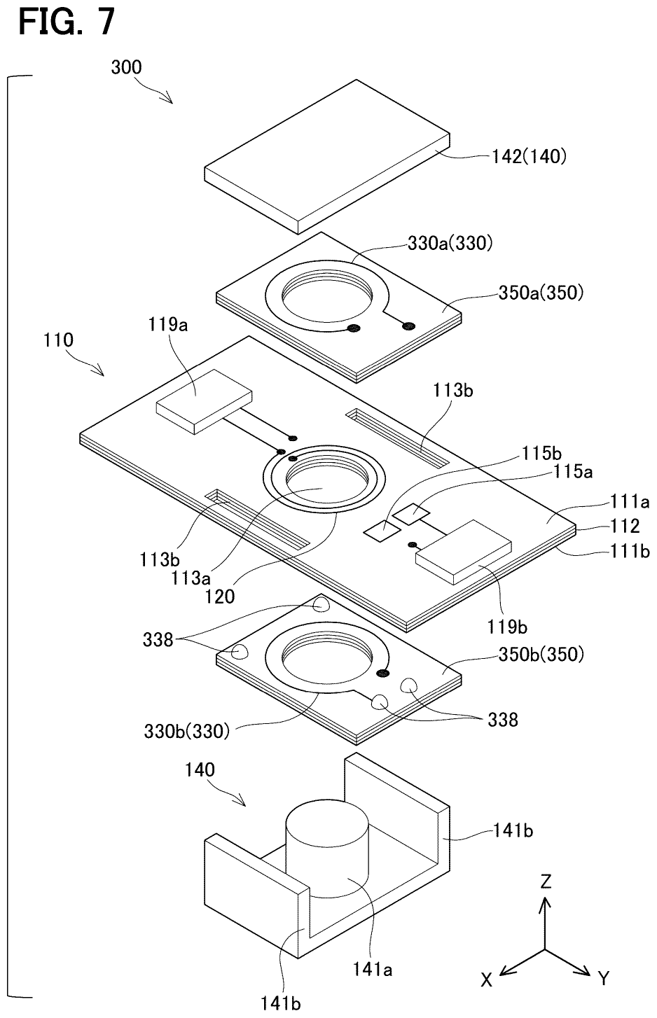

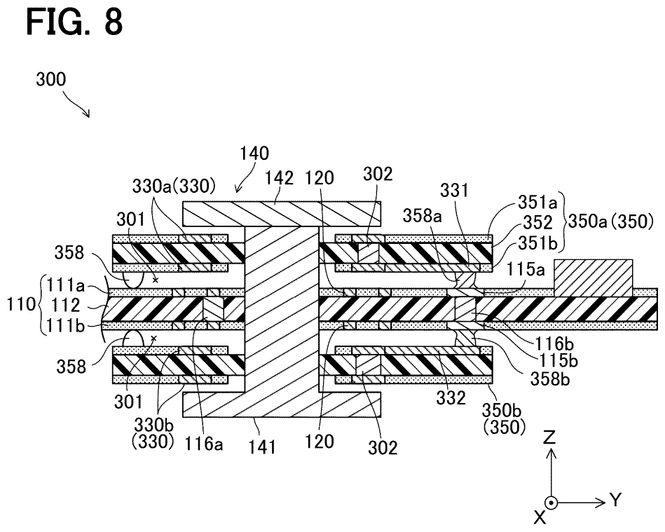

FIGS. 6 to 8 show a transformer 300 according to a third embodiment. FIG. 6 is a perspective view of the transformer 300, and FIG. 7 is an exploded perspective view of the transformer 300. FIG. 8 is a cross-sectional view of the transformer 300 taken along line VIII-VIII in FIG. 6. The transformer 300 has a second coil 330 which is different from the second coil 130 of the transformer 100 of the first embodiment. The other configurations of the transformer 300 are the same as those of the transformer 100 of the first embodiment.

The second coil 330 of the transformer 300 is arranged on the sub-boards 350a and 350b. The transformer 300 includes the sub-boards 350a and 350b. The sub-board 350a is disposed on the front side of the printed circuit board 110, and the sub-board 350b is disposed on the back side of the printed circuit board 110. Similar to the printed circuit board 110, the sub-board 350a, 350b has a three-layer structure in which an insulating layer 352 is interposed between conductor layers 351a and 351b.

As shown in FIGS. 7 and 8, a coil 330a is formed by a wiring pattern on the conductor layer 351a, 351b of the sub-board 350a. The coil 330a of the conductor layer 351a and the coil 330a of the conductor layer 351b are connected in series by a via 302. A coil 330b is formed by a wiring pattern on the conductor layer 351a, 351b of the sub-board 350b, and the coils 330b are connected in series through the via 302.

Four protrusions 358 are formed on the surface of the sub-board 350b facing the printed circuit board 110. The tips of the four protrusions 358 are in contact with the printed circuit board 110, and the sub-board 350b is held parallel to the printed circuit board 110. The four protrusions 358 form an air gap 301 between the sub-board 350b and the printed circuit board 110. The sub-board 350a has four protrusions 358, and the tips of the four protrusions 358 are in contact with the printed circuit board 110 to form an air gap 301 between the sub-board 350a and the printed circuit board 110. The four protrusions 358 hold the sub-board 350a parallel to the printed circuit board 110 with the air gap 301 therebetween.

The protrusion 358 is a conductive land. One land (the protrusion 358a shown in FIG. 8) is connected to the coil 330a via the wiring pattern 331. The protrusion 358a is connected to the terminal 115a on the front surface of the printed circuit board 110. The terminal 115a is electrically connected to the terminal 115b on the back surface of the printed circuit board 110 by a via 116b. The protrusion 358b of the sub-board 350b is in contact with the terminal 115b. The protrusion 358b is a land and has electrical conductivity. The protrusion 358b is connected to the wiring pattern 332 formed on the conductor layer of the sub-board 350b, and the wiring pattern 332 is connected to the coil 330b. The coils 330a and 330b are connected in series via the wiring pattern 331, 332, the protrusion 358a, 358b, the terminal 115a, 115b, and the via 116b, to form one second coil 330. The protrusions 358 other than the protrusions 358a, 358b only need to function as spacers for ensuring the air gap 301 between the printed circuit board 110 and the sub-board 350a, 350b, and may not be connected to other conductor patterns.

The sub-board 350a, 350b including the second coil 330 is fixed to the printed circuit board 110 and located outside the printed circuit board 110. The sub-board 350a, 350b is smaller than the printed circuit board 110. Therefore, compared to a case where all coils are formed on a printed circuit board, the volume of the printed circuit board for the entire transformer can be made smaller.

The first coil 120 and the second coil 330 oppose to each other. The air gap 301 between the first coil 120 and the second coil 330 provides insulation between the first coil 120 and the second coil 330.

The first coil 120 and the second coil 330 face each other, and the cylinder 141a of the core 140 passes through the centers of the first coil 120 and the second coil 330. The core 140 surrounds the first coil 120 and the second coil 330. A magnetic field is generated in the core 140 by the current flowing through the first coil 120, and the magnetic field generates an induced current in the second coil 330.

The features and advantages of the transformer 300 of the third embodiment will be described. The transformer 300 includes the first coil 120 formed by a wiring pattern on the printed circuit board 110, and the second coil 330 formed by a wiring pattern on the sub-board 350a, 350b arranged outside the printed circuit board 110. The sub-board 350a, 350b is smaller than the printed circuit board 110. With this structure, the volume of the printed circuit board that constitutes the transformer can be made smaller, compared with a case where the second coil is formed by a wiring pattern inside the printed circuit board 110.

The points to be noted regarding the technique of the embodiments will be described. In the transformer 100, 200, 300, a coil is formed by a wiring pattern on the conductor layer 111a, 111b of the printed circuit board 110, to constitute a first coil. The first coil may be composed of only a coil on one conductor layer of a printed circuit board, or may be composed of coils on three or more conductor layers.

As shown in FIGS. 2 and 7, the coil 130a is a wiring pattern wound twice around the conductor layer 111a of the printed circuit board 110 to surround the through hole 113a. The coil 130a may be a wiring pattern wound around the through hole 113a only once, or may be a wiring pattern wound around three or more times.

The second coil 130 is joined to the conductor layer 111a, 111b on which the first coil 120 is formed. By joining the second coil 130 to the conductor layer 111a, 111b on which the first coil 120 is formed, there is no need to provide a separate conductor layer for joining the second coil.

In the transformer 100, 200, the coils 130a and 130b are arranged on the sides of the printed circuit board 110, and the series connection of the coils 130a and 130b forms the second coil 130. The second coil may be located on only one side of the printed circuit board.

The first coil 120 has four turns. The first coil may have more than four turns or less than four turns. The second coil 130 (330) has four turns. The second coil may have more than four turns or less than four turns.

The first coil 120 may correspond to a primary coil of a transformer, and the second coil 130 (330) may correspond to a secondary coil of the transformer. Alternatively, the first coil 120 may correspond to a secondary coil of a transformer, and the second coil 130 (330) may correspond to a primary coil of the transformer.

In the transformer 300, the sub-board 350a, 350b has the protrusions 358, the tips of the protrusions 358 abut against the printed circuit board 110. The protrusions 358 may be provided on the printed circuit board 110, and the tips may abut against the sub-board 350a (350b). That is, a protrusion may be provided on one of the printed circuit board and the sub-board, and the tip of the protrusion may abut against the other of the printed circuit board and the sub-board.

The cross-sectional area of the first coil 120 and the second coil 130 (330) is determined according to the expected magnitude of the current. It may be preferable that a low current flows through the first coil 120 formed by a wiring pattern on the printed circuit board 110, and a large current flows through the second coil 130 made of flat wire or the second coil 330 formed by a wiring pattern on the sub-board 350.

The terminal 115a, 115b is plated with a conductive material. The terminal 115a, 115b is joined to the printed circuit board 110 by soldering.

The second coil 130 of the transformer 100 may be fixed to the printed circuit board 110 with an insulating adhesive. The thickness of the adhesive and the distance between the windings may be determined according to the upper limit of the inter-winding capacitance allowed between the first coil and the second coil. The thickness of the insulating layer of the printed circuit board and the sub-board may be determined based on the upper limit of the allowable inter-winding capacitance.

Although specific examples of the present disclosure have been described in detail above, these are merely examples and do not limit the scope of the present description. The techniques described in the claims include various modifications and modifications of the specific examples illustrated above. In addition, the technical elements described in the present description or the drawings exhibit technical usefulness alone or in various combinations, and are not limited to the combinations described in the claims at the time of filing. In addition, the techniques illustrated in the present specification or drawings can achieve multiple purposes at the same time, and achieving one of the purposes itself has technical usefulness.

What is claimed is:

1. A transformer comprising:
a printed circuit board including a first coil formed by a wiring pattern on a conductor layer; and
a second coil disposed outside the printed circuit board to oppose the first coil.

2. The transformer according to claim 1, wherein the second coil is a flat wire wound edgewise for more than one turn.

3. The transformer according to claim 2, wherein the second coil is joined to a conductor layer on which the first coil is formed.

4. The transformer according to claim 2, wherein
the flat wire is covered with an insulating coating, and
the insulating coating has a dielectric breakdown voltage higher than a dielectric breakdown voltage of an insulating layer of the printed circuit board.

5. The transformer according to claim 2, wherein a gap is provided between the second coil and the printed circuit board.

6. The transformer according to claim 1, wherein the second coil is formed by a wiring pattern on a sub-board that is smaller than the printed circuit board.

7. The transformer according to claim 6, wherein one of the printed circuit board and the sub-board has a protrusion, and the other of the printed circuit board and the sub-board is in contact with the protrusion.

8. The transformer according to claim 1, further comprising a core passing through the first coil and the second coil to surround the first coil and the second coil.
